(19) United States
(12) Patent Application Publication
(10) Pub. No.: US 2017/0097122 A1
(43) Pub. Date: Apr. 6, 2017

(54) LED LAMP HOLDER

(71) Applicant: HSU LI YEN, TAIPEI COUNTY (TW)

(72) Inventor: HSU LI YEN, TAIPEI COUNTY (TW)

(21) Appl. No.: 14/875,811

(22) Filed: Oct. 6, 2015

(51) Int. Cl. F21K 99/00

(52) U.S. Cl. CPC F21K 9/1355

(57) ABSTRACT

An LED lamp holder includes a frame ring that has slits for fittingly receiving retaining portions of some inserts; the inserts, each including the retaining portion, a top piece that has a hook, a positioning hole and a bore, and a bottom piece that has a hook and a bore, wherein the hooks of one insert are to be combined with the bores another insert, so that all the inserts are connected as a series; and a locking seat that has notches for receiving the retaining portions of the inserts, and has pins corresponding to the positioning holes of the inserts. After the pins are inserted into the positioning holes of the inserts, stamping is performed on the pins to fix the frame ring, the inserts and the locking seat as an unity, so as to form the LED lamp holder.

### BACKGROUND OF THE INVENTION

1. Field of the Invention

The present invention relates to LED lamps, and more particularly to an LED lamp holder.

2. Description of Related Art

The conventional LED lamp holder has an accommodating tube whose outer wall is provided with a plurality of separated slits each for a plate to insert therein. The accommodating tube has an upper opening to which a locking seat is fixedly attached. To make a lamp using this holder, an LED unit is affixed to the locking seat by means of screws. Then a lampshade covers the LED unit from above and a starter is installed into a lower opening of the accommodating tube to complete the lamp.

However, in the known configuration, the accommodating tube must have a certain thickness to provide sufficient strength. This substantive thickness creates increased weight and manufacturing costs. Hence, the present invention is made to provide an LED lamp holder with reduced manufacturing costs and enhanced market competitiveness.

### SUMMARY OF THE INVENTION

The present invention provides an LED lamp holder featuring an improved assembling structure. The LED lamp holder comprises a frame ring, being circumferentially formed with a plurality of slits, each of which is configured to fittingly receive and position a retaining portion of one of inserts; the inserts, each including a trunk, a lateral piece formed by folding the trunk at one lateral side of the trunk, the retaining portion extended upward from a part of an upper end of the trunk, a top piece that is formed by folding the trunk at the rest of the upper end of the trunk and has a hook extended outward, a positioning hole and a bore, and a bottom piece that is formed by folding the trunk at a lower end of the trunk and has a hook extended outward and a bore, wherein the hook at the top piece and the hook at the bottom piece of one said insert are to be combined with the bore at the top piece and the bore at the bottom piece of another said insert, so that all the inserts are connected as a series; and a locking seat, being a round plate that has a bottom extended with a boss and being circumferentially formed with a plurality of notches, each of which is for the retaining portion of one said insert to insert, and has the bottom provided with a plurality of pins each corresponding to the positioning hole at the top piece of one said insert, whereby after the pins are inserted into the positioning holes at the top pieces of the inserts, stamping is performed on each of the pins to fix the frame ring, the inserts and the locking seat as an unity, so as to form the LED lamp holder.

The present invention uses the engagements of: the slits of the frame ring and the retaining portions of the inserts; the hooks and bores of the insert; the notches of the locking seat and the retaining portions of the inserts; and the pins of the locking seat and the positioning holes of the inserts, to position the lateral pieces of the inserts along the frame ring, so that a space is formed among the inserts for a starter to install therein. Since the inserts are made through stamping metal sheets, the material required by manufacturing the LED lamp holder can be reduced as compared to the prior art.

### BRIEF DESCRIPTION OF THE DRAWINGS

FIG. 1 is an exploded view of an LED lamp holder of the present invention;

FIG. 2 is another exploded view of the LED lamp holder taken from a different viewpoint;

FIG. 3 is a perspective view of a frame ring of the LED lamp holder;

FIG. 4 is a perspective view of an insert of the LED lamp holder;

FIG. 5 is a perspective view of the LED lamp holder;

FIG. 6 is another perspective view of the LED lamp holder taken from a different viewpoint;

FIG. 7 is an exploded view of an LED lamp using the LED lamp holder of the present invention; and

FIG. 8 is a perspective view of the LED lamp.

### DETAILED DESCRIPTION OF THE INVENTION

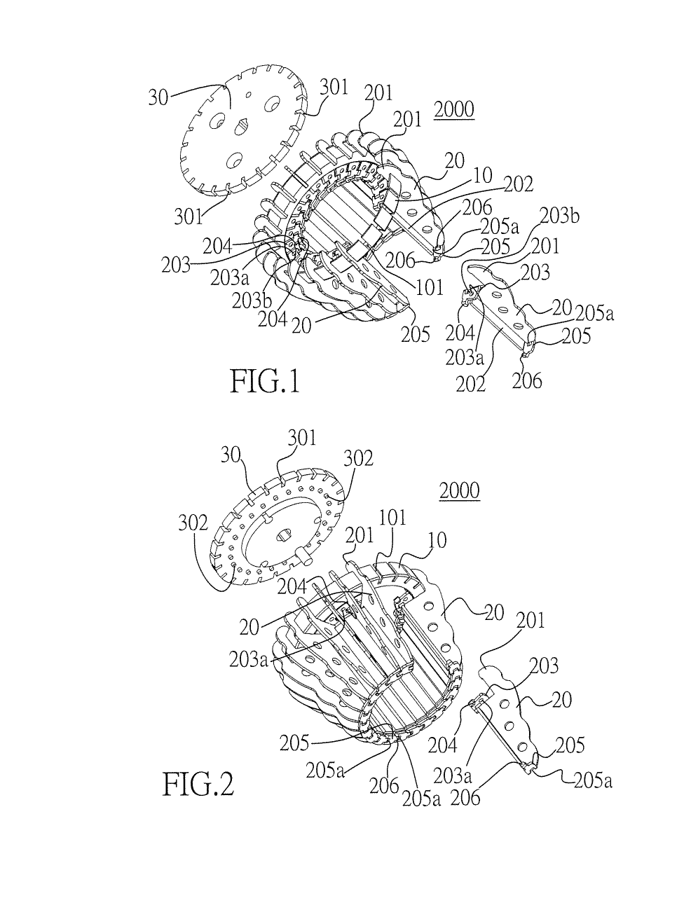

As shown in FIG. 1 and FIG. 2, according to the present invention, an LED lamp holder comprises a frame ring 10, inserts 20, and a locking seat 30.

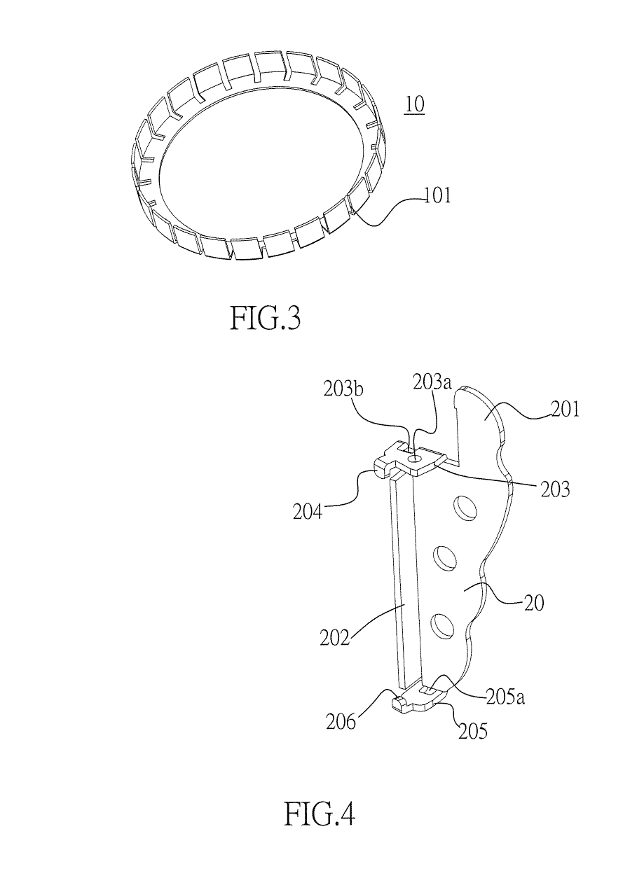

The frame ring 10 (also referring to FIG. 3) is circumferentially formed with a plurality of slits 101. Each of the slits is configured to fittingly receive and position a retaining portion 201 of one of the inserts 20.

The insert 20 (also referring to FIG. 4) has a trunk. A lateral piece 202 formed by folding the trunk at one lateral side of the trunk. A retaining portion 201 is extended upward from a part of the upper end of the trunk. A top piece 203 is formed by folding the trunk at the rest of the upper end of the trunk. A hook 204 is extended from the top piece 203. The top piece 203 is formed with a positioning hole 203a and a bore 203b. A bottom piece 205 is formed by folding the trunk at the lower end of the trunk. A hook 206 is extended from the bottom piece 205. The bottom piece 205 is formed with a bore 205a.

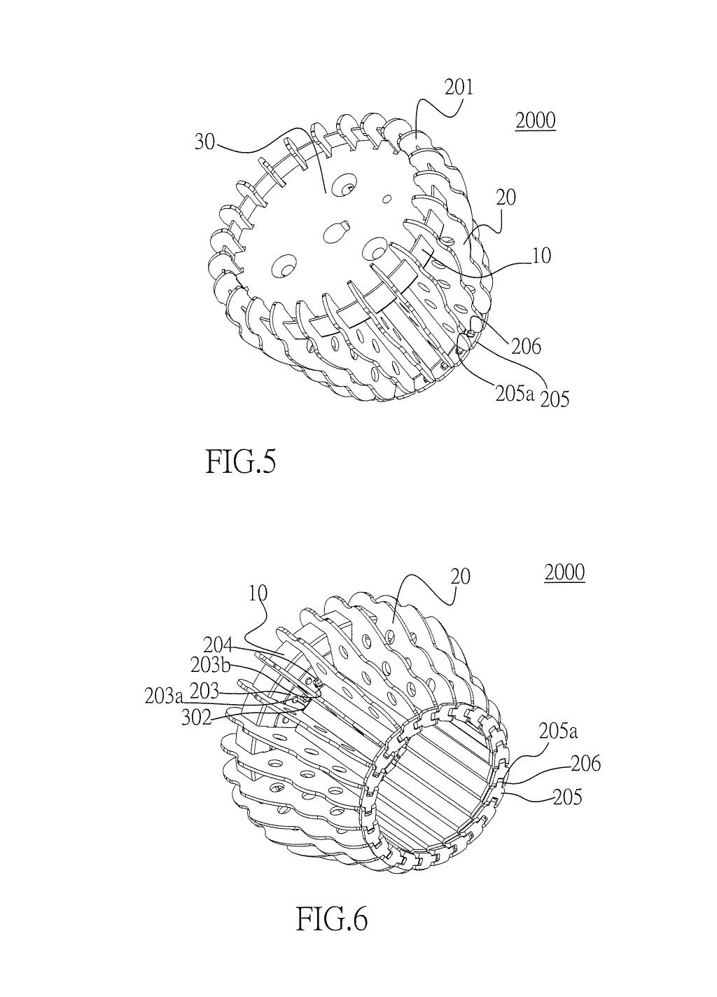

Therein, as also shown in FIG. 5 and FIG. 6, the hook 204 at the top piece 203 and the hook 206 at the bottom piece 205 of one said insert 20 are to be combined with the bore 203b at the top piece 203 and the bore 205a at the bottom piece 205 of another said insert 20, so that all the inserts 20 can be connected as a series.

The locking seat 30, as also seen in FIG. 2 and FIG. 6, is a round plate has its bottom extended with a boss. The locking seat is circumferentially formed with a plurality of notches 301. Each of the notches 301 is for the retaining portion 201 of one said insert 20 to insert. The locking seat 30 also has its bottom provided with a plurality of pins 302 each corresponding to the positioning hole 203a at the top piece 203 of one said insert 20. After the pins 302 are inserted into the positioning holes 203a at the top pieces 203 of the inserts 20, stamping is performed on each of the pins 302 to fix the assembly as a unity, as shown in FIG. 5 and FIG. 6, so as to form the disclosed LED lamp holder 2000.

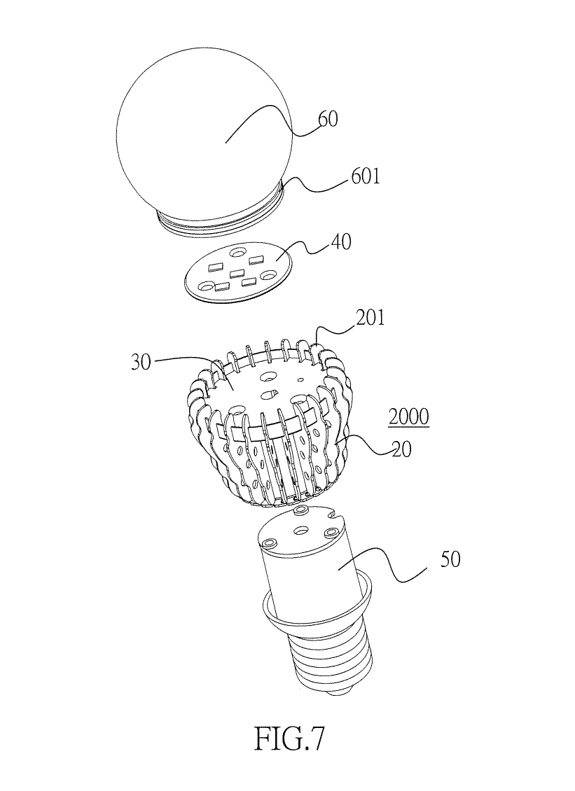

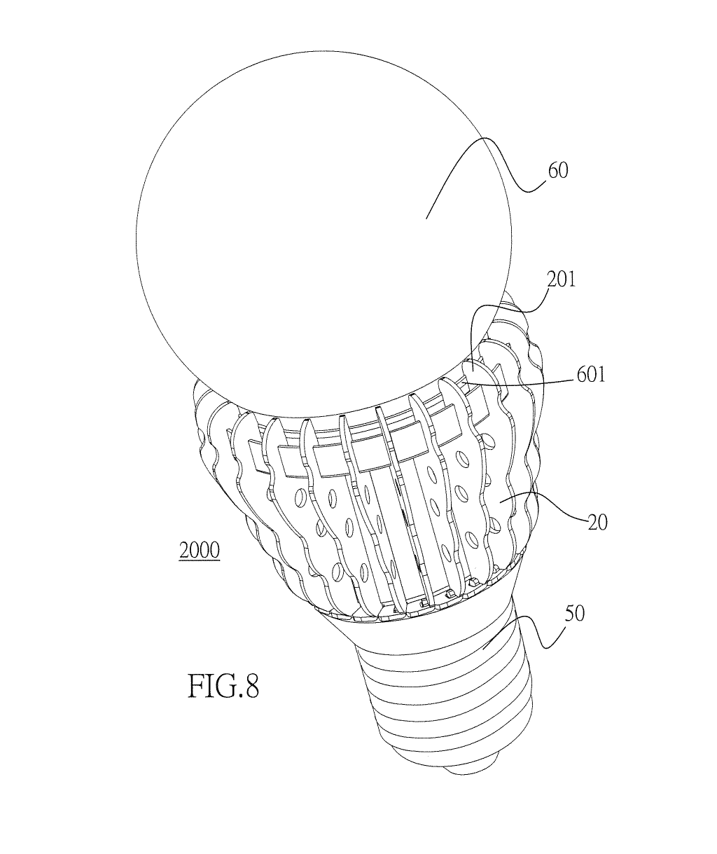

FIG. 7 and FIG. 8 are an exploded view and a perspective view of an LED lamp according to the present invention. As shown, the LED lamp holder 2000 defines therein a space for receiving a starter 50. Then an LED lamp 40 is placed on the locking seat 30 of the LED lamp holder 2000. Screws passing through the LED lamp 40 and the LED lamp holder 2000 are screwed into threaded holes formed on the starter 50, so as to hold the components together. At last, a lampshade 60 is assembled to the LED lamp holder 2000 so that the retaining portions 201 of the inserts 20 of the LED lamp holder 2000 engage with a flange 601 formed on the lampshade 60, thereby holding the lampshade 60 in position.

To sum up, with the configuration described previously the present invention is exactly effective in solving the problems seen in the prior art and is highly inventive.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. An LED lamp holder, comprising:
a frame ring, being circumferentially formed with a plurality of slits, each of which is configured to fittingly receive and position a retaining portion of one of inserts;
the inserts, each including a trunk, a lateral piece formed by folding the trunk at one lateral side of the trunk, the retaining portion extended upward from a part of an upper end of the trunk, a top piece that is formed by folding the trunk at the rest of the upper end of the trunk and has a hook extended outward, a positioning hole and a bore, and a bottom piece that is formed by folding the trunk at a lower end of the trunk and has a hook extended outward and a bore, wherein the hook at the top piece and the hook at the bottom piece of one said insert are to be combined with the bore at the top piece and the bore at the bottom piece of another said insert, so that all the inserts are connected as a series; and
a locking seat, being a round plate that has a bottom extended with a boss and being circumferentially formed with a plurality of notches, each of which is for the retaining portion of one said insert to insert, and has the bottom provided with a plurality of pins each corresponding to the positioning hole at the top piece of one said insert, whereby after the pins are inserted into the positioning holes at the top pieces of the inserts, stamping is performed on each of the pins to fix the frame ring, the inserts and the locking seat as a unity, so as to form the LED lamp holder.
